(19) United States
(12) Patent Application Publication
(10) Pub. No.: US 2010/0280884 A1
(43) Pub. Date: Nov. 4, 2010

(54) Automated carpool matching

(76) Inventors: Uri Levine, Kfar Saba (IL); Amir Shinar, Moshav Ein-Vered (IL); Ehud Shabtai, Tel Aviv (IL); Yuval Shmuelevitz, Ramat Hasharon (IL)

Correspondence Address: EITAN MEHULAL LAW GROUP, 10 Abba Eban Blvd. PO Box 2081, Herzlia, 46120, IL

(21) Appl. No.: 12/453,133

(22) Filed: Apr. 30, 2009

(51) Int. Cl. G07B 15/00

(52) U.S. Cl. 705/13

(57) ABSTRACT

Automated carpool matching. For example, a method includes: collecting data from a first mobile communication device of a first user and from a second mobile communication device of a second user; determining a first travel pattern associated with the first user and a second travel pattern associated with the second user; determining a match between the first and second travel patterns; and generating a carpool proposal directed at the first and second users.

### FIELD

Some embodiments are related to the field of mobile computerized devices.

### BACKGROUND

In the last few decades, the number of vehicles used by drivers is continuously increasing, and traffic congestion became a common phenomenon and an urban problem. Due to traffic congestion, many drivers spend a significant amount of time, sometimes over one hour, in order to travel by car over a relatively short route. This may result in, for example, a waste of precious time that the driver needs to spend in his vehicle, instead of at home or at work, as well as significant frustration by the driver. Furthermore, a longer travel time typically corresponds to a higher utilization of fuel by the vehicle, which in turn corresponds to higher fuel expenses for the driver. Additionally, heavy traffic contributes to an increase in pollution, thereby creating a possible health hazard in some urban areas as well as an environmental problem.

Some communities attempt to reduce traffic congestion by various ways. For example, relatively inexpensive public transportation (e.g., buses and trains) is offered, in order to serve as alternative to utilization of cars. Additionally, tolls are imposed on utilization of particular road segments (e.g., highway portions) or transportation elements (e.g., bridges and tunnels). Some drivers utilize route navigation systems able to receive real-time traffic updates, in order to identify in advance traffic congestion in particular road segments, thereby allowing drivers to take a detour route which may be less congested

In some roads, a High-Occupancy Vehicle (HOV) lane is designated and reserved for vehicles having a minimum number of persons therein (e.g., two or more persons, three or more persons, or four or more persons). In some roads, the average velocity of vehicles in the HOV lane may be higher than the average velocity of vehicles in non-HOV lanes. Accordingly, there may be an incentive for a driver to avoid driving alone, and to attempt to drive to his destination together with one or more passenger, in order to utilize the suitable HOV lane.

The designation of HOV lanes, as well as the continuous increase in fuel costs, motivate some people to join into a “carpool” in order to travel together, in a single vehicle, from a common starting point to a common destination point. For example, two co-workers who also live in proximity to each other, may travel together from home to work and/or vice versa, in a single car, in order to save fuel expenses, and optionally in order to utilize a HOV lane reserved for vehicles having two or more persons.

### SUMMARY

Some embodiments include, for example, devices, systems, and methods of automated carpool matching.

In some embodiments, for example, a method includes: collecting data from a first mobile communication device of a first user and from a second mobile communication device of a second user; determining a first travel pattern associated with the first user and a second travel pattern associated with the second user; determining a match between the first and second travel patterns; and generating a carpool proposal directed at the first and second users.

In some embodiments, for example, determining the match is based on one or more user-defined preferences.

In some embodiments, for example, the one or more user-defined preferences comprise at least one of: a preference related to departing time-of-day; a preference related to arrival time-of-day; a preference related to departing day-of-week; a preference related to arrival day-of-week; a preference related to geographic distance between an origin location of the first user and an origin location of the second user; and a preference related to geographic distance between a destination location of the first user and a destination location of the second user.

In some embodiments, for example, the one or more user-defined preferences comprise at least one of: a preference related to gender of one or more carpool participants; a preference related to age of one or more carpool participants; a preference related to occupation of one or more carpool participants; a smoking or non-smoking preference related to one or more carpool participants; an air conditioning preference related to one or more carpool participants; and a type of vehicle preference related to one or more carpool participants.

In some embodiments, for example, the method includes: based on mapping information, determining that a road segment of a common route of the first and second users comprises a High Occupancy Vehicle (HOV) lane reserved for vehicles having a minimum number of persons therein, wherein the minimum number of persons is greater than two; determining a match between the first and second travel patterns and one or more additional travel patterns of one or more additional users of one or more additional mobile communication devices; and generating another carpool proposal directed at the first user, the second user, and the one or more additional users.

In some embodiments, for example, the method includes: calculating a benefit for the first user, the benefit associated with accepting the carpool proposal relative to rejecting the carpool proposal; and conveying to the first user said benefit in association with said carpool proposal.

In some embodiments, for example, the benefit comprises at least one of: an estimated saving in gas expenses; an estimated saving in parking expenses; an estimated saving in travel tolls; and an estimated saving in travel time.

In some embodiments, for example, the method includes collecting at least one of: Global Positioning System (GPS) data from said first user; input entered by the first user indicative of the first user's travel pattern; and input entered by the first user indicative of one or more parameters of a requested carpool.

In some embodiments, for example, the method includes: conveying the carpool proposal to the first user; and preventing conveyance to the first user of a real-life identifier of the second user if the second user does not convey his pre-approval.

In some embodiments, for example, the mobile communication device comprises a device selected from the group consisting of: a cellular phone, a Personal Digital Assistant (PDA) device, a smart-phone, a Portable Navigation Device (PND), a mobile route guidance device, a mobile mapping device, a mobile traffic updates device, a vehicular navigation device, and a vehicular dashboard device.

In some embodiments, for example, a system includes: a route analysis module to collect data from a first mobile communication device of a first user and from a second mobile communication device of a second user, and to determine a first travel pattern associated with the first user and a second travel pattern associated with the second user; and a carpool matching module to determine a match between the first and second travel patterns, and to generate a carpool proposal directed at the first and second users.

In some embodiments, for example, the carpool matching module is to determine the match based on one or more user-defined preferences.

In some embodiments, for example, the one or more user-defined preferences comprise at least one of: a preference related to departing time-of-day; a preference related to arrival time-of-day; a preference related to departing day-of-week; a preference related to arrival day-of-week; a preference related to geographic distance between an origin location of the first user and an origin location of the second user; and a preference related to geographic distance between a destination location of the first user and a destination location of the second user.

In some embodiments, for example, the one or more user-defined preferences comprise at least one of: a preference related to gender of one or more carpool participants; a preference related to age of one or more carpool participants; a preference related to occupation of one or more carpool participants; a smoking or non-smoking preference related to one or more carpool participants; an air conditioning preference related to one or more carpool participants; and a type of vehicle preference related to one or more carpool participants.

In some embodiments, for example, based on mapping information, the route analysis module is to determine that a road segment of a common route of the first and second users comprises a High Occupancy Vehicle (HOV) lane reserved for vehicles having a minimum number of persons therein, wherein the minimum number of persons is greater than two; and the carpool matching module is to determine a match between the first and second travel patterns and one or more additional travel patterns of one or more additional users of one or more additional mobile communication devices, and to generate another carpool proposal directed at the first user, the second user, and the one or more additional users.

In some embodiments, for example, the system includes a benefit calculator to calculate a benefit for the first user, the benefit associated with accepting the carpool proposal relative to rejecting the carpool proposal; and the carpool matching module is to convey to the first user said benefit in association with said carpool proposal.

In some embodiments, for example, the benefit comprises at least one of: an estimated saving in gas expenses; an estimated saving in parking expenses; an estimated saving in travel tolls; and an estimated saving in travel time.

In some embodiments, for example, the route analysis module is to collect at least one of: Global Positioning System (GPS) data from said first user; input entered by the first user indicative of the first user's travel pattern; and input entered by the first user indicative of one or more parameters of a requested carpool.

In some embodiments, for example, the carpool matching module is to convey the carpool proposal to the first user, and to prevent conveyance to the first user of a real-life identifier of the second user if the second user does not convey his pre-approval.

In some embodiments, for example, the mobile communication device comprises a device selected from the group consisting of: a cellular phone, a Personal Digital Assistant (PDA) device, a smart-phone, a Portable Navigation Device (PND), a mobile route guidance device, a mobile mapping device, a mobile traffic updates device, a vehicular navigation device, and a vehicular dashboard device.

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic flow-chart of a method of automated carpool matching, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The terms “plurality” or “a plurality” as used herein include, for example, “multiple” or “two or more”. For example, “a plurality of items” includes two or more items.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a Personal Navigation Device (PND), a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smartphone” device, a wired or wireless handheld device (e.g., BlackBerry®, Palm® Treo™, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth®, Global Positioning System (GPS), IEEE 802.11 (“Wi-Fi”), IEEE 802.16 (“Wi-Max”), ZigBee™, Ultra-Wideband (UWB), Global System for Mobile communication (GSM), 2G, 2.5G, 3G, Third Generation Partnership Project (3GPP), 3GPP Long Term Evolution (LTE), 3.5G, or the like. Some embodiments may be used in conjunction with various other devices, components, systems, and/or networks.

The terms “wireless device” or “mobile device” or “mobile communication device” or “wireless communication device” as used herein include, for example, a device capable of wireless communication, a mobile phone, a cellular phone, a PDA capable of wireless communication, a handheld device capable of wireless communication, or the like.

The terms “web” or “Web” as used herein includes, for example, the World Wide Web; a global communication system of interlinked and/or hypertext documents, files, web-sites and/or web-pages accessible through the Internet or through a global communication network; including text, images, videos, multimedia components, hyperlinks, or other content.

The term “user” as used herein includes, for example, a person or entity that owns a computing device or a wireless device; a person or entity that operates or utilizes a computing device or a wireless device; or a person or entity that is otherwise associated with a computing device or a wireless device.

At an overview, some embodiments include devices, systems, and methods of automated carpool matching. Some embodiments may generate community-based automated matching among two or more carpool commuters, in order to improve and/or optimize energy consumption and/or and transportation resources. A data gathering and analysis process is used for the automated carpool matching, as well as for calculation of the cost saving and/or the time saving associated with such carpooling.

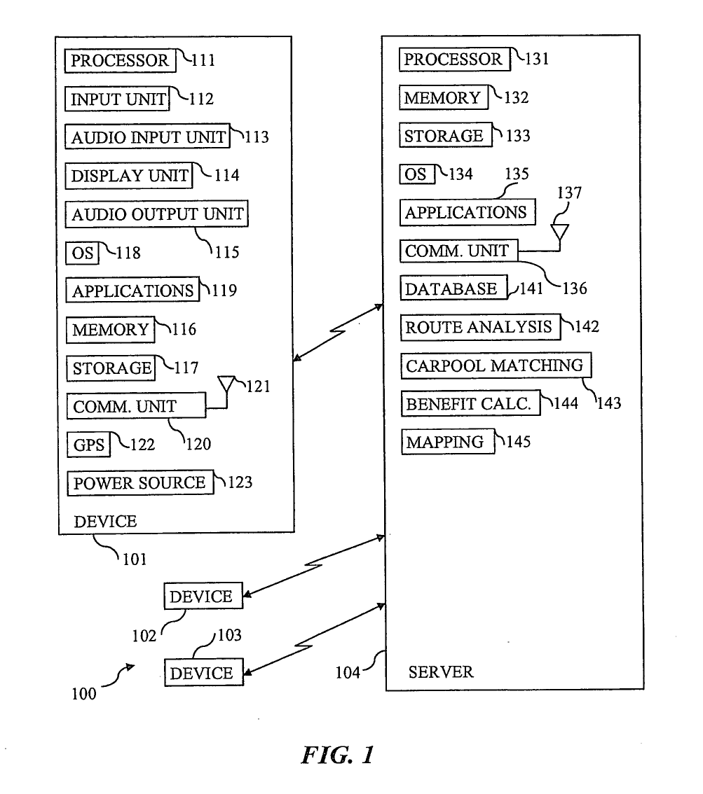

FIG. 1 schematically illustrates a block diagram of a system 100 in accordance with some demonstrative embodiments. System 100 includes multiple devices, for example, devices 101-103, as well as a server 104.

In some embodiments, each one of devices 101-103 may be implemented, for example, as a portable device, a handheld device, a Portable Navigation Device (PND), a cellular phone, a “smartphone” device, a Personal Digital Assistant (PDA) device, an on-board or off-board device, a hybrid device (e.g., combining features of a PDA and a cellular phone), a wireless communication device, a vehicular device, an on-board device, a dashboard device, or the like. In some embodiments, each one of devices 101-103 may optionally be, or may include functions of, a portable audio player, a portable video player, a portable audio/video player, a portable media player, a portable device having a touch-screen, a relatively small computing device, a non-desktop computer or computing device, a portable device, a “Carry Small Live Large” (CSLL) device, an Ultra Mobile Device (UMD), an Ultra Mobile PC (UMPC), a Mobile Internet Device (MID), a Consumer Electronic (CE) device, an “Origami” device or computing device, a device that supports Dynamically Composable Computing (DCC), a context-aware device, or the like

Devices 101-103 may be able to communicate among themselves, and/or may be able to communicate with server 104 (e.g., a route guidance server, a real-time server, a traffic server, a traffic updates server, a traffic prediction server), using one or more wireless communication links and/or networks. Communication may be performed, for example, over a shared access medium, an a-synchronic or asynchronous wireless network, a synchronic wireless network, a managed wireless network, a non-managed wireless network, a burstable wireless network, a non-burstable wireless network, a scheduled wireless network, a non-scheduled wireless network, a combination of networks or links, or the like. Communication may be performed using one or more suitable protocols, for example, Transmission Control Protocol (TCP), User Datagram Protocol (UDP), Hypertext Transfer Protocol (HTTP), Wireless Application Protocol (WAP), or other suitable protocol(s). The communication may include, for example, transmissions by devices 101-103 to server 104 of their location and/or velocity; transmissions by server 104 to devices 101-103 indicating traffic updates, traffic predictions, dynamic route guidance, and/or mapping information; or the like.

Each one of devices 101-103 may be implemented using suitable hardware components and/or software components. For demonstrative purposes, components of device 101 are shown, whereas similar components of devices 102-103 are not shown. For example, device 101 may include a processor 111, an input unit 112, an audio input unit 113, a display unit 115, an audio output unit 116, a memory unit 117, a storage unit 118, a communication unit 119, and/or other suitable components.

Processor 111 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or other suitable multi-purpose or specific processor or controller. Processor 111 executes instructions, for example, of an Operating System (OS) 118 or of one or more applications 119.

Input unit 112 includes, for example, a keyboard, a keypad, a mouse, a touch-pad, a touch-screen, a joystick, a track-ball, a stylus, or other suitable pointing unit or input device.

Audio input unit 113 may include, for example, a microphone or a line-in socket able to receive audio input from the user of device 101. The received audio may optionally include speech commands, which may trigger voice-activated or voice-operated actions to be performed by device 101. For example, the audio input unit may be used to receive from a user a speech indication of a destination (e.g., an address of a destination), and this audio input may be used by a navigation application of device 101 in order to guide the user in navigating to that destination.

Display unit 114 may include, for example, a Liquid Crystal Display (LCD) display unit, a plasma display unit, or other suitable types of displays or screens. In some embodiments, display unit 114 may include a touch-screen, such that display unit 114 may be able to present output as well as to receive touch-based input or multi-touch input.

Audio output unit 115 may include, for example, one or more speakers or earphones or line-out sockets able to produce audio output. In some embodiments, for example, output generated by device 101 may be presented visually on the display unit 114, and/or may be presented audibly as audio output using the audio output unit 115.

Memory unit 116 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 117 includes, for example, a hard disk drive, a floppy disk drive, a Compact Disk (CD) drive, a CD-ROM drive, a Digital Versatile Disk (DVD) drive, an internal or external database or repository, or other suitable removable or non-removable storage units. Memory unit 116 and/or storage unit 117 may, for example, store data processed by device 101.

Communication unit 120 includes, for example, a wired or wireless transceiver, a wired or wireless modem, a wired or wireless Network Interface Card (NIC) or adapter, or other unit suitable for transmitting and/or receiving communication signals, blocks, frames, transmission streams, packets, messages and/or data. In some embodiments, for example, communication unit 120 may include a wireless Radio Frequency (RF) transceiver able to transmit and/or receive wireless RF signals, e.g., through one or more antennas 121 or sets of antennas. For example, such transceiver may be implemented using a transmitter, a receiver, a transmitter-receiver, or one or more units able to perform separate or integrated functions of transmitting and/or receiving wireless communication signals, blocks, frames, transmission streams, packets, messages and/or data.

Antenna 121 may include an internal and/or external antenna, for example, a RF antenna, a dipole antenna, a monopole antenna, an omni-directional antenna, an end fed antenna, a circularly polarized antenna, a micro-strip antenna, a diversity antenna, or any other type of antenna suitable for transmitting and/or receiving wireless communication signals, blocks, frames, transmission streams, packets, messages and/or data.

Device 101 may optionally include a GPS receiver 122, able to receive signal(s) from one or more satellites (or other signal sources) and to determine the spatial location of device 101, for example, based on trilateration or other suitable method.

In some embodiments, device 110 further includes a power source 123, for example, a power-cell or battery, a rechargeable power-cell or battery, one or more electrochemical cells, a lithium ion (Li-ion) battery, a Li-ion polymer battery, a nickel cadmium (NiCd) battery, a nickel metal hydride (NiMH) battery, a nickel hydrogen (NIH2) battery, or the like. Power source 123 may be associated with a power controller, which may be able to control, regulate and/or modify the power (e.g., the voltage and/or the current) supplied by the power source 123 to other components of device 101 (e.g., to processor 111, to display unit 114, or the like).

In some embodiments, some or all of the components of device 101 are enclosed in a common housing or packaging, and are interconnected or operably associated using one or more wired or wireless links.

In some embodiments, each one of devices 102-103 may include components which may be similar to the components of device 101. In some embodiments, server 104 may include components which may be similar to the components of device 101, for example, a processor 131, a memory unit 132, a storage unit 133, an OS 134, one or more application 135, a communication unit 136, an antenna 137, or the like. In some embodiments, server 104 may be stationary, non-mobile or non-portable.

In some embodiments, each one of devices 101-103 may be associated with a user, for example, a driver or a passenger. System 100 may be a centralized system which assess drivers and commuters travel patterns, as well as driving behaviors and historical routes, and optionally also information exchanged through a community of users (e.g., of a route navigation system, a mapping system, or a traffic updates system).

In some embodiments, system 100 may take into account the designation of HOV lane(s), in order to optimize matchmaking among commuters travelling on similar or nearby routes. For example, in some embodiments, system 100 may selectively suggest a two-person carpool to two drivers that typically drive separately from a first point to a second point, along a road which has a “two or more persons” HOV lane; whereas the system may selectively suggest a three-person carpool to three drivers that typically drive separately from a first point to a second point, along a road which has a “three or more persons” HOV lane.

In some embodiments, carpool matching may be performed based on data gathered from multiple sources. A first data source includes GPS data received from mobile devices and/or vehicular devices (e.g., devices 101-103) of various drivers and/or community members, substantially in real-time. Such data is collected and accumulated for historical analysis and/or determination of, for example, travel route, travel patterns, time of travel (e.g., time-of-day, day-of-week, day-of-month), parking location, or the like.

A second data source includes manual setup and configuration inputs received from community members, for example, indicating their source point and destination point (e.g., home, work, grocery store, or the like), preferred travel time-of-day, willingness to participate in carpools, personal information (e.g., gender, age), level of flexibility or rigidness in their department time and/or their arrival time, or the like.

A third data source includes information submitted to, or exchanged through, one or more community forums (e.g., online forum, bulletin board, Blogs, message posting services, or the like) in which carpool requests and/or proposals are made among community members, namely, drivers and/or passengers.

In some embodiments, data collected from these sources may be stored by server 104 in a central database 141. In some embodiments, frequently travelled locations (e.g., origins and destinations) or routes (e.g., road segments) may be derived by collecting GPS points from the community members' devices (e.g., devices 101-103). A route analysis module 142 of server 104 analyzes each travel record, and identifies the relevant starting and ending points of the travel, as well as departure and arrival times; the identified data is then allocated to the profile of the relevant user. The accumulation of similar close-by geographical locations is analyzed and associated with potential daily routine visit places or possible common routes (e.g., home to work in the morning; work to home in the evening; home to beach on Saturday morning; beach to home on Saturday afternoon). Optionally, the user of the relevant device 101-103 may be prompted to confirm a hypothesis about the various locations, time of travel, or other attributes (e.g., weekly frequency) of an identified route.

In some embodiments, data may be collected and/or analyzed only with regard to registered users who pre-approved their participation. For example, carpool participation registration may be performed using a Web interface (e.g., filling out and submitting a form on a web-site) and/or through community forums. The information is accumulated in database 141 for correlation with user profiles and other user-related information which is accumulated automatically upon the user's pre-approval.

In some embodiments, the user registration process may include collection of carpool-related or travel-related user preferences from the user, for example: gender preference (e.g., a female passenger requesting to join only a female driver); age preference (e.g., a passenger requesting to join only a driver who is at least 25 years old); occupation preferences (e.g., a user preference to join a carpool of Web developers, or of teachers); hobby preferences (e.g., a user preference to join a carpool of fans of the Chicago Bulls basketball team, or to join a carpool of persons interested in tennis); typical or required departure time; typical or required arrival time; preference to be a driver; preference to be a passenger; preference regarding the maximum size or the minimum size or the exact size of the carpool; preference regarding smoking or non-smoking carpools; indications of vehicles or types of vehicles that are preferred or non-preferred vehicles (e.g., private vehicles, minivans, Sport Utility Vehicles (SUVs), air-conditioned vehicles); indications of preferred carpool behavior (e.g., talking on mobile phones is allowed or not-allowed, music is played or non-played); or other user preferences related to the user, to other possible members of the carpool, to the vehicle, to the route, or the common trip.

In some embodiments, analysis of data accumulated in the database 141 may be performed in daily schedule, such that data is sorted and grouping of community members is performed by a carpool matching module 143 based on the provided and analyzed information. In some embodiments, grouping may be based on, for example, zip code range, neighborhood range, preferred user proximity range as indicated by the user, optionally utilizing ranges or threshold parameters, for example: up to one mile of detour for collecting carpool members; up to seven minutes for collecting carpool members; joining with carpool members that live within a common area having a pre-defined radius; or the like.

In some embodiments, carpool matching may be optimized based on one or more criteria, for example, distance from or to the common destination, time-of-day travel information, day-of-week travel information, or other parameters, in order to provide an increased benefit for all the members of the suggested carpool. For example, in some embodiments, the system may suggest a carpool combination in which the distance among carpool members origin positions is minimal; a carpool combination in which the distance among carpool members destinations is minimal; a carpool combination in accordance with user preferences (e.g., a smoking carpool, a non-smoking carpool, an all-female carpool); or the like.

In some embodiments, once a relevant user-based grouping is made, the grouping may be correlated with carpool requests in the relevant area(s), and matchmaking may be performed. In some embodiments, matchmaking may be substantially anonymously (e.g., via an internal messaging system of an online forum), until all relevant carpool members provided their consent to reveal their identity or contact details to other carpool members.

In some embodiments, the information provided to carpool participants (e.g., users of devices 101-103) may further include, for example, potential cost saving (e.g., gas expenses, car-related expenses, public transportation expenses, parking expenses, transportation tolls, road tolls, bridge tolls, tunnel tolls, ferry tolls, highway tolls, or the like), estimated time saving (e.g., based on typical velocity of cars in a HOV lane versus a non-HOV lane), as well as other suitable information which may promote the service and/or provide benefit to the user. These information items may be calculated by a benefits calculation module 144, which may optionally utilize manually-updated or automatically-updated information (e.g., gas prices).

In a demonstrative example, a first user utilizes device 101, and drives his car every weekday morning (Monday through Friday; excluding weekends) from his home to his work, departing at around 08:30 and arriving at around 09:10. His home is located at First Avenue and 14 Street in New York City; his work is located at Third Avenue and 96 Street in New York City. Server 104 collects from device 101 various data, for example, GPS information, velocity at particular times, or the like. The gathered data is stored in database 141. The route analysis module 142 analyzes the data and determines that the user of device 101 travels, every weekday at around 08:30, from an origin located within 300 feet of First Avenue and 14 Street, to a destination located within 400 feet of Third Avenue and 96 Street. The route parameters are stored in database 141, in association with an identifier or username or record of the first user, or as part of this user's profile.

Similarly, a second user utilizes device 102, and drives his car every Monday morning from his home to his Karate class, departing at around 08:35 and arriving at around 09:15. His home is located at First Avenue and 15 Street in New York City; the Karate class is located at Third Avenue and 98 Street in New York City. Server 104 collects from device 102 various data, for example, GPS information, velocity at particular times, or the like. The gathered data is stored in database 141. The route analysis module 142 analyzes the data and determines that the user of device 102 travels, every Monday at around 08:35, from an origin located within 250 feet of First Avenue and 15 Street, to a destination located within 300 feet of Third Avenue and 98 Street. The route parameters are stored in database 141, in association with an identifier or username or record of the second user, or as part of this user's profile.

In contrast, a third user works as a night-clerk in a grocery store, utilizes device 103, and drives his car every weekday evening from his home to his work, departing at around 18:00 and arriving at around 18:40. His home is located at Second Avenue and 99 Street; his work is located at First Avenue and 13 Street. Server 104 collects from device 103 various data, for example, GPS information, velocity at particular times, or the like. The gathered data is stored in database 141. The route analysis module 142 analyzes the data and determines that the user of device 103 travels, every Tuesday at around 18:00, from an origin located within 350 feet of Second Avenue and 99 Street, to a destination located within 200 feet of First Avenue and 13 Street. The route parameters are stored in database 141, in association with an identifier or username or record of the third user, or as part of this user's profile

The carpool matching module 143 periodically analyzes the information that the route analysis module 142 stored in database 141. The carpool matching module 143 may determine, that the first and second users are a good match for a possible carpool on Monday morning; since their travel profiles include origin points that are close-by, destination points that are close-by, and departing time-of-day parameters that are close-by. The carpool matching module 143 is able to determine that this matching is unique to Monday, and not to other weekdays. The carpool matching module 143 is able to determine that there is no possible match between the second user and the third user, for carpool purposes. The carpool matching module 143 may be able to further determine a possible carpool match, between the first user (who may return from work to home at around 18:00 every weekday) and the third user (who travels from home to work every Tuesday at around 18:00).

In some embodiments, the carpool matching module 143 may take into account other criteria or user-selected conditions, prior to suggesting to the relevant users any carpool proposals. For example, the first user is a male, and the second user is a female, who indicated in her user profile that she is interesting in female-only carpools. Accordingly, based on this condition, the carpool matching module 143 rejects the possible carpool proposal (which includes the first and second users), and does not propose it to these users. Similar rejection of possible carpool combinations may be based on other user preferences, for example, smoking or non-smoking, relative distance among the origin points, relative distance among the destination points, or the like.

In some embodiments, the carpool proposal may be conveyed to the relevant users through a forum-based messaging system which does not expose the identity of the users until they actively consent to such exposure. In some embodiments, a carpool proposal may remain anonymous or semi-anonymous, without showing a real-life identifier of a possible participant, until that participant approves to expose his identity to, other possible participant(s). In some embodiments, the system may avoid, block or prevent such exposure of real-life identifying details of participants or possible-participants until they specifically pre-approve such exposure.

In some embodiments, a user may be presented with several carpool proposals, as well as the benefits associated with each carpool proposal (as calculated by the benefit calculation module 144). In some embodiments, carpool proposals may be presented to the user together with a comparison chart of various attributes (e.g., not necessarily benefits) of each carpool proposal; for example, number of carpool members, distance between origin points of carpool members, distance between destination points of carpool members, age or gender of carpool members, or other suitable information which may facilitate the decision of the user as to whether or not to accept the suggested carpool proposal(s).

In some embodiments, the carpool matching module 143 may take into account HOV lane information which may be obtained, for example, from a mapping module 145. For example, the carpool matching module 143 may identify a pair of two users which match for a particular carpool; but may further identify that the estimated route of the carpool trips includes a road segment having a HOV lane reserved for carpools of three or more persons. Accordingly, the carpool matching module 143 may temporarily avoid or delay or block or prevent presenting the carpool proposal to the two matched users; instead, the carpool matching module 143 may search for a further match between the two already-matched users and a third user, such that a carpool of three persons may be created, thereby allowing the common vehicle to travel along the HOV lane.

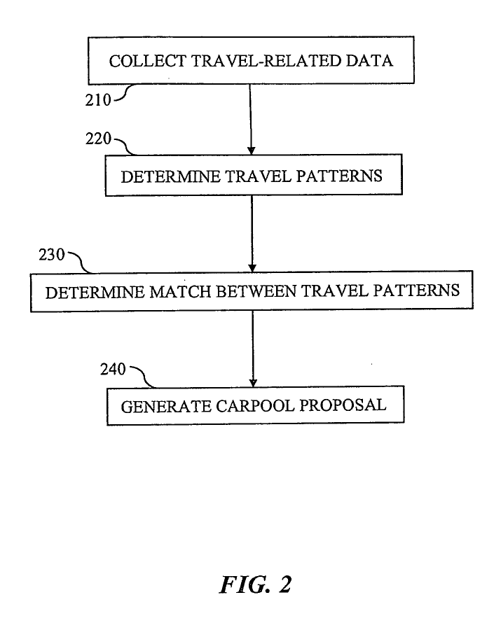

FIG. 2 is schematic flow-chart of a method of automated carpool matching, in accordance with some demonstrative embodiments. Operations of the method may be used, for example, by system 100 of FIG. 1, by server 103 of FIG. 1, and/or by other suitable units, devices and/or systems.

In some embodiments, the method may include, for example, collecting travel-related data from a first mobile communication device of a first user and from a second mobile communication device of a second user (block 210).

In some embodiments, the method may include, for example, determining a first travel pattern associated with the first user and a second travel pattern associated with the second user (block 220).

In some embodiments, the method may include, for example, determining a match between the first and second travel patterns (block 230).

In some embodiments, the method may include, for example, generating a carpool proposal directed at the first and second users (block 240).

Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A method comprising:
collecting data from a first mobile communication device of a first user and from a second mobile communication device of a second user;
determining a first travel pattern associated with the first user and a second travel pattern associated with the second user;
determining a match between the first and second travel patterns; and
generating a carpool proposal directed at the first and second users.

2. The method of claim 1, wherein determining the match comprises:
determining the match based on one or more user-defined preferences.

3. The method of claim 2, wherein the one or more user-defined preferences comprise at least one of:
a preference related to departing time-of-day;
a preference related to arrival time-of-day;
a preference related to departing day-of-week;
a preference related to arrival day-of-week;
a preference related to geographic distance between an origin location of the first user and an origin location of the second user; and
a preference related to geographic distance between a destination location of the first user and a destination location of the second user.

4. The method of claim 2, wherein the one or more user-defined preferences comprise at least one of:
a preference related to gender of one or more carpool participants;
a preference related to age of one or more carpool participants;
a preference related to occupation of one or more carpool participants;
a smoking or non-smoking preference related to one or more carpool participants;
an air conditioning preference related to one or more carpool participants; and
a type of vehicle preference related to one or more carpool participants.

5. The method of claim 1, further comprising:
based on mapping information, determining that a road segment of a common route of the first and second users comprises a High Occupancy Vehicle (HOV) lane reserved for vehicles having a minimum number of persons therein, wherein the minimum number of persons is greater than two;
determining a match between the first and second travel patterns and one or more additional travel patterns of one or more additional users of one or more additional mobile communication devices; and
generating another carpool proposal directed at the first user, the second user, and the one or more additional users.

6. The method of claim 1, further comprising:
calculating a benefit for the first user, the benefit associated with accepting the carpool proposal relative to rejecting the carpool proposal; and
conveying to the first user said benefit in association with said carpool proposal.

7. The method of claim 6, wherein the benefit comprises at least one of:
an estimated saving in gas expenses;
an estimated saving in parking expenses;
an estimated saving in travel tolls; and
an estimated saving in travel time.

8. The method of claim 1, wherein collecting data comprises collecting at least one of:
Global Positioning System (GPS) data from said first user;
input entered by the first user indicative of the first user's travel pattern; and
input entered by the first user indicative of one or more parameters of a requested carpool.

9. The method of claim 1, further comprising:
conveying the carpool proposal to the first user; and
preventing conveyance to the first user of a real-life identifier of the second user if the second user does not convey his pre-approval.

10. The method of claim 1, wherein the mobile communication device comprises a device selected from the group consisting of:
a cellular phone, a Personal Digital Assistant (PDA) device, a smart-phone, a Portable Navigation Device (PND), a mobile route guidance device, a mobile mapping device, a mobile traffic updates device, a vehicular navigation device, and a vehicular dashboard device.

11. A system comprising:
a route analysis module to collect data from a first mobile communication device of a first user and from a second mobile communication device of a second user, and to determine a first travel pattern associated with the first user and a second travel pattern associated with the second user; and
a carpool matching module to determine a match between the first and second travel patterns, and to generate a carpool proposal directed at the first and second users.

12. The system of claim 11, wherein the carpool matching module is to determine the match based on one or more user-defined preferences.

13. The system of claim 12, wherein the one or more user-defined preferences comprise at least one of:
a preference related to departing time-of-day;
a preference related to arrival time-of-day;
a preference related to departing day-of-week;
a preference related to arrival day-of-week;
a preference related to geographic distance between an origin location of the first user and an origin location of the second user; and
a preference related to geographic distance between a destination location of the first user and a destination location of the second user.

14. The system of claim 12, wherein the one or more user-defined preferences comprise at least one of:
a preference related to gender of one or more carpool participants;
a preference related to age of one or more carpool participants;
a preference related to occupation of one or more carpool participants;
a smoking or non-smoking preference related to one or more carpool participants;
an air conditioning preference related to one or more carpool participants; and
a type of vehicle preference related to one or more carpool participants.

15. The system of claim 11, wherein, based on mapping information, the route analysis module is to determine that a road segment of a common route of the first and second users comprises a High Occupancy Vehicle (HOV) lane reserved for vehicles having a minimum number of persons therein, wherein the minimum number of persons is greater than two;
wherein the carpool matching module is to determine a match between the first and second travel patterns and one or more additional travel patterns of one or more additional users of one or more additional mobile communication devices, and to generate another carpool proposal directed at the first user, the second user, and the one or more additional users.

16. The system of claim 11, further comprising:
a benefit calculator to calculate a benefit for the first user, the benefit associated with accepting the carpool proposal relative to rejecting the carpool proposal;
wherein the carpool matching module is to convey to the first user said benefit in association with said carpool proposal.

17. The system of claim 16, wherein the benefit comprises at least one of:
an estimated saving in gas expenses;
an estimated saving in parking expenses;
an estimated saving in travel tolls; and
an estimated saving in travel time.

18. The system of claim 11, wherein the route analysis module is to collect at least one of:
Global Positioning System (GPS) data from said first user;
input entered by the first user indicative of the first user's travel pattern; and
input entered by the first user indicative of one or more parameters of a requested carpool.

19. The system of claim 11, wherein the carpool matching module is to convey the carpool proposal to the first user, and to prevent conveyance to the first user of a real-life identifier of the second user if the second user does not convey his pre-approval.

20. The system of claim 11, wherein the mobile communication device comprises a device selected from the group consisting of:
a cellular phone, a Personal Digital Assistant (PDA) device, a smart-phone, a Portable Navigation Device (PND), a mobile route guidance device, a mobile mapping device, a mobile traffic updates device, a vehicular navigation device, and a vehicular dashboard device.
